(19) United States
(12) Patent Application Publication
(10) Pub. No.: US 2020/0094320 A1
(43) Pub. Date: Mar. 26, 2020

(54) DEVICE AND METHOD FOR PRODUCING A THREE-DIMENSIONAL WORKPIECE

(71) Applicant: SLM Solutions Group AG, Lübeck (DE)

(72) Inventors: Toni Adam Krol, Lubeck (DE); Henner Schoeneborn, Lubeck (DE); Dieter Schwarze, Lubeck (DE); Karsten Huebinger, Lubeck (DE)

(21) Appl. No.: 16/495,980

(22) PCT Filed: Mar. 8, 2018
(86) PCT No.: PCT/EP2018/055755

§ 371 Date: Sep. 20, 2019

(30) Foreign Application Priority Data
Mar. 24, 2017 (EP) 17162785.4

(51) Int. Cl. B22F 3/105; B29C 64/153; B33Y 30/00; B33Y 10/00; B33Y 50/02; B33Y 40/00

(52) U.S. Cl. CPC B22F 3/105; B29C 64/153; B33Y 30/00; B22F 2003/1056; B33Y 50/02; B33Y 40/00; B33Y 10/00

(57) ABSTRACT

The invention relates to a device (10) for producing a three-dimensional workpiece by carrying out an additive layering process, wherein the device (10) comprises:
a build area (17) that is configured to receive a raw material powder layer;
a powder application device (14) that is configured to deploy the raw material powder layer onto the build area (17);
an irradiation system (20) that is configured to selectively irradiate the raw material powder layer on the build area (17);

wherein the device (10) is configured to provide at least one gas flow (48) that is directed along an axis (A) extending from a first edge region (44) of the build area (17) towards a second edge region (46) of the build area (17); and wherein the device (10) comprises at least one gas flow guide element (36) that is configured to divert at least a part of the gas flow (48) away from the build area (17) before said gas flow (48) reaches the second edge region (46);

wherein the gas flow guide element (36) comprises a gas supply portion (56) that is configured to supply a fresh gas flow (54) along the build area (17). The invention also concerns a method for producing a three-dimensional workpiece.

The present invention relates to a method and an apparatus for producing a three-dimensional workpiece. More specifically, the invention relates to setting a desired gas flow across a build area in which a raw material powder layer is provided, said raw material powder layer being selectively irradiated by means of a irradiation system.

Selective laser melting or laser sintering is an additive layering process by which pulverulent, in particular metallic and/or ceramic raw materials, can be processed to three-dimensional workpieces of complex shapes. To that end, a raw material powder layer is applied onto a carrier defining a build area and subjected to laser radiation in a site selective manner in dependence on the desired geometry of the workpiece that is to be produced. The laser radiation penetrating into the powder layer causes heating and consequently melting or sintering of the raw material powder particles. Further raw material powder layers are then applied successively to the layer on the carrier that has already been subjected to laser treatment, until the workpiece has the desired shape and size. Selective laser melting or laser sintering can be used in particular for the production of prototypes, tools, replacement parts or medical prostheses, such as, for example, dental or orthopaedic prostheses, on the basis of CAD data.

It is further known to provide inert or protective gas to avoid unwanted chemical reactions of the irradiated material e.g. with surrounding oxygen. For example, an apparatus for producing moulded bodies from pulverulent raw materials by selective laser melting is described in EP 1 793 979 A1. The prior art apparatus comprises a process chamber which accommodates a plurality of carriers for the shaped bodies to be manufactured. A powder layer preparation system comprises a powder reservoir holder that can be moved to and fro across the carriers in order to apply a raw material powder to be irradiated with a laser beam onto the carriers. The process chamber is connected to a protective gas circuit comprising a supply line via which a protective gas may be supplied to the process chamber in order to establish a protective gas atmosphere within the process chamber. The protective gas circuit further comprises a discharge line via which protective gas containing particulate impurities such as, for example, residual raw material may leave the process chamber.

Moreover, it is known to produce a desired gas flow pattern, so that the raw material powder layer is reliably covered with gas. In this context, EP 2 862 651 A1 discloses a respective solution in which gas is guided across a build area that is subdivided into several irradiation areas. This solution is, however, directed to specific layouts of irradiation areas and may thus not be applicable in certain production scenarios.

The invention is directed at the object of providing a method and an apparatus which allow the production of a high-quality three-dimensional workpiece and which are marked by an increased application range.

This object is addressed by a device as defined in claim 1 and a method as defined in claim 15.

Accordingly, a device and a method for producing a three-dimensional workpiece by carrying out an additive layering process is provided. In general, of the introductory remarks relating to the general background of the present technical field may also apply to the present invention. Specifically, the device as well as the method of the present invention may be configured to carry out a cyclic additive layering process in which layers of raw material powder layer are deployed, selectively irradiated and thus solidified, to then deploy a subsequent raw material powder layer on top of the just solidified one. Thereby, a workpiece can be built up from the raw material powder in a layer-by-layer manner. Also, in the context of the present invention, any teaching referring to a single raw material powder layer may also include that this teaching is applicable to all, to at least 50% or to at least 20% of the total number of raw material powder layers used for building up a given workpiece.

According to the present invention, the device comprises a build area that is configured to receive a raw material powder layer. The build area may be defined as or by a carrier of the device. Specifically, the build area may relate to an area of the device in which the workpiece can be produced from the raw material powder. The build area may generally define a maximum footprint or cross-section of said workpiece. Moreover, the device may comprise a process chamber in which said build area (as well as any of the further components of the device discussed in the following) may be arranged.

The raw material powder preferably is a metallic powder, in particular a metal alloy powder, but may also be a ceramic powder or a powder containing different materials. The powder may have any suitable particle size or particle size distribution. It is, however, preferable to process powders of particle sizes <100 μm. The process chamber may be sealable against the ambient atmosphere, i.e. against the environment surrounding the process chamber, in order to be able to maintain a controlled atmosphere, in particular an inert atmosphere within the process chamber. By controlling the atmosphere within the process chamber, the occurrence of undesired chemical reactions, in particular oxidation reactions, upon irradiating the raw material powder with electromagnetic or particle radiation can be prevented.

The optional carrier may be disposed in the process chamber and/or may be a rigidly fixed carrier. Preferably, however, the carrier is designed to be displaceable in vertical direction so that, with increasing construction height of a workpiece, as it is built up in layers from the raw material powder, the carrier can be moved downwards in the vertical direction. A plurality of irradiation areas may be defined on a surface of the carrier or, to put it differently, within an irradiation plane extending in parallel to said carrier and/or the build area. Said irradiation plane, preferably, includes a raw material powder layer that is to be irradiated next. For example, at least four irradiation areas may be provided that are arranged in a grid or matrix pattern.

The device further comprises a powder application device that is configured to deploy the raw material powder onto the build area. The powder application device may be configured according to known solutions and, for example, may be movable across the build area to deploy a sequence of raw material powder layers on top of one another.

The device further comprises an irradiation system that is configured to selectively irradiate the raw material powder layer on the build area. In particular, the raw material powder applied onto the carrier may be subjected to electromagnetic or particle radiation in a site-selective manner in dependence on the desired geometry of the workpiece that is to be produced. For doing so, the irradiation system preferably is adapted to irradiate radiation (e.g. laser radiation) onto the raw material powder which causes a site-selective melting of the raw material powder particles.

The irradiation system may comprise a plurality of irradiation units. As further detail below, each irradiation unit may be assigned to an individual irradiation area defined on the surface of the carrier or, to put it differently, defined within an irradiation plane extending in parallel to the carrier. Each irradiation unit may further be configured to selectively irradiate electromagnetic or particle radiation onto the raw material powder applied onto its assigned irradiation area.

In general, each irradiation unit may comprise a radiation beam source, in particular a laser beam source. It is, however, also conceivable that plural irradiation units are associated with a single radiation beam source, wherein a radiation beam provided by the single radiation beam source, by suitable means such as, for example, beam splitters and/or mirrors, may be split and/or deflected as required so as to direct the radiation beam provided by the radiation beam source to the associated irradiation units. Further, each irradiation unit may comprise at least one optical unit for guiding and/or processing a radiation beam emitted by the radiation beam source and supplied to the irradiation unit. The optical unit may comprise optical elements such an object lens, in particular an f-theta lens, and/or a scanner unit, the scanner unit preferably comprising a diffractive optical element and a deflection mirror.

Each irradiation unit may be controlled such that the radiation beam emitted by the radiation beam source is irradiated onto the raw material powder applied onto the irradiation area associated with the irradiation unit in a site selective manner and independent of the irradiation of other irradiation areas not associated with the irradiation unit in question. In other words, each irradiation area defined on the carrier may be individually and independently irradiated using a desired irradiation pattern. For example, if desired, a small sized three-dimensional workpiece may be built-up in a single irradiation area by selectively irradiating the single irradiation area with electromagnetic or particle radiation by means of the irradiation unit associated with the irradiation area. Preferably, however, plural irradiation areas defined on the carrier are simultaneously irradiated with electromagnetic or particle radiation by suitable controlling the irradiation units associated with the irradiation areas thus allowing a large three-dimensional workpiece to be built-up in an additive layer construction process within a relatively short time and thus at reasonable costs.

The invention further contemplates arranging a plurality of irradiation units (e.g. at least four, at least eight or at least sixteen irradiation units) of the irradiation system according to a predetermined pattern. This may relate to, for example, a grid- or matrix-pattern. In general, the irradiation system and in particular any irradiation units comprised thereby may be arranged oppositely to the build area. For example, the irradiation system and/or the irradiation units may be arranged above and so as to face the build area. This may be achieved by arranging the irradiation system at or in parallel to an upper ceiling portion of the process chamber.

The device may further be configured to provide at least one gas flow that is directed along an axis extending from a first edge region of the build area towards a second edge region of the build area. The first and second edge region may be different from one another and, in particular, may be oppositely arranged to one another. In one example, the build area has a substantially rectangular shape. In this case, the first and second edge regions may include different sides of said rectangular shape and, in particular, opposite sides thereof. The gas flow may be provided in and/or supplied to a process chamber of the device, said process chamber being configured according to one of the above examples and containing e.g. the build area.

In general, the gas flow may be provided by means of a gas supply arrangement of the device. Said gas supply arrangement may, similar to known examples, generally be configured to produce or provide a gas flow across the build area. Additionally or alternatively, at least part of said gas flow may be provided by a gas flow guide element discussed below. Specifically, in case of the device comprising two gas flow guide elements being arranged adjacent to one another, the gas flow may be provided by one of the gas flow guide elements and flow towards the other.

The gas flow may comprise an inert gas such as, for example, Argon, Nitrogen or the like. It is, however, also conceivable that the gas flow comprises air. The gas may be supplied by means of a suitable conveying device such as, for example, a pump or a blower. The device, and in particular an optional gas supply arrangement thereof, may comprise or be connectable to known gas circuit configurations, comprising further elements, such as filters, pumps, cooling equipment and the like.

In general, the gas flow may be provided so as to flow across the build area and, in particular, along a surface of a raw material powder deposited thereon. For providing the desired gas flow, at least one gas inlet may be provided, that is preferably arranged close to the first edge region. Said gas inlet may be connected to a pump or blower for creating a pressure required for making the gas stream along the build area. Additionally or alternatively, at least one gas outlet may be provided for removing gas from the build area, said gas outlet being preferably arranged close to the second edge region.

In general, gas that is supplied to the build area may be described as “fresh gas” when it has not yet been guided across or along said build area. When flowing across the build area, particulate impurities may accumulate in the gas. In such a state, the gas may generally be referred to as “used gas”. The device may be configured to at least partially remove said used gas from the build area or, in other words, discharge said used gas from a process chamber containing the build area. This may be carried out by means of the above-mentioned gas outlet. Said gas outlet may be connected to a pump or a blower to create a suction force for removing the gas from the build area. Note that any of the gas inlet or gas outlet may be comprised by the optional gas supply arrangement of the device.

In summary, while the raw material powder applied onto the carrier is selectively irradiated with electromagnetic or particle radiation, the fresh gas supplied to the build area by means of e.g. the gas supply arrangement, upon flowing along the build area, is increasingly loaded with particulate impurities such as, for example, raw material powder particles or welding smoke particles. The gas may be removed from the build area via an optional gas outlet in a state resembling used gas due to containing particulate impurities. Additionally or alternatively, the gas may interact with a gas flow guide element discussed below so as to be at least partially diverted away from the build area. Hence, particulate impurities generated in the process chamber upon irradiating the raw material powder on the carrier with electromagnetic or particle radiation are purged from the build area by the gas flow. By removing particulate impurities from the build area, excessive absorption of radiation energy and/or shielding of the radiation beams emitted by the irradiation system may be avoided. Also, contamination of areas of the build area which have not yet been irradiated can be avoided. Specifically, contamination of such areas by an undesired deposition of particles or splatters can be avoided.

The device of the invention is generally configured to further improve the supply of fresh gas to the build area and thereby improve the quality of the overall production process. Specifically, the device further comprises a gas flow guide element that is configured to divert at least part of the gas flow away from the build area before said gas flow reaches the second edge region, wherein the gas flow guide element comprises a gas supply portion that is configured to supply a fresh gas flow along (at least part of) the build area.

The gas flow guide element may thus be configured to remove and/or discharge at least part of the gas flow on its way across the build area. This way, at least a certain share of said gas flow that may have picked up impurities on its way across the build area towards the gas flow guide element (i.e., a certain volume of used gas) is prevented from further flowing along the build area.

The gas flow guide element may, in particular in parallel to diverting gas away from the build area, also supply a fresh gas flow from its gas supply portion to the build area. The volume of supplied fresh gas may be controlled in accordance with a volume of used gas that is diverted away from the build area. Specifically, the volumes of supplied fresh gas and the volume of diverted used gas may be proportionate and/or may be at least approximately equivalent to one another.

For diverting the gas away from the build area, the gas flow guide element may comprise a gas diversion portion, e.g. a gas diversion nozzle. The gas may enter said portion in order to be diverted away from the build area. The gas flow guide element may further comprise or be connectable to a gas circuit. For example, the gas flow guide element may be configured to divert the gas flow so as to enter or re-enter such a gas circuit, e.g. in order to be guided towards a filter or other cleaning units, so as to remove the particulate impurities therefrom.

The gas supply portion of the gas flow guide element may likewise comprise or be connected to a gas circuit which may be the same gas circuit to the gas supply portion is connected. Likewise, the optional gas supply arrangement and the gas flow guide element (or at least its gas supply portion) may comprise or be connected to one and the same gas circuit, wherein said gas circuit may be comprised by the overall device. The gas supply portion may comprise an opening or a nozzle to direct the fresh gas towards the build area. Specifically, the gas supply portion may be configured to supply the fresh gas in an at least partially tangential manner to a surface of the build area, i.e. the fresh gas being supplied to the build area by the gas supply portion so as to flow along said build area.

The gas supply element may comprise a main portion housing at least part of the gas supply portion as well as at least part of a gas diversion portion. The main portion may comprise two channel portions, one channel portion allowing a gas flow towards the gas supply portion and another channel portion allowing a gas flow away from the gas diversion portion (and from the build area). These channel portions may be separated by a common wail portion (or, differently put, by a central wall) of the gas supply element.

The gas supply element (and in particular its main portion) may span across the build area. For example, the gas supply element may extend between different edge portions of the build area and, preferably, between opposite edge portions thereof. These edge portions may be different from the first and second edge portions between which the axis extends along which the gas flow is provided. To put it differently, the gas supply element may extend within a plane that is non-parallel to the build area and/or non-parallel to the at least one gas flow. Specifically, said plane may extend orthogonally to the build area and/or to the gas flow.

Overall, the invention thus contemplates deliberately interrupting a gas flow across the build area between the first and second edge region and at least partially replacing it with a fresh gas flow, wherein said interruption and replacement may take place after a predetermined interval or in predetermined stages. Thus, while flowing across the area, the gas flow may be periodically refreshed or even fully replaced by providing new volumes of fresh gas, especially when a plurality of gas flow guide elements is provided.

Generally, the gas supply portion and the gas diversion portion may be arranged at different sides of the gas flow guide element. For example, they may be arranged at sides of the gas flow guide element facing away from one another or, in general, may be arranged so as to face away from one another. In one example, the gas supply portion may be arranged at a side of the gas flow guide element facing the second edge region, whereas the gas diversion portion may be arranged at a side of the gas flow guide element facing the first edge region. A relative position between the gas supply portion and gas diversion portion may be constant. For example, both of these portions may assume fixed positions within gas flow guide element and/or may not be movable relative to one another.

In general, a width of the gas flow guide element when viewed along the gas flow axis may be less than 20 cm, less than 10 cm, less than 5 cm or less than 2 cm. This may relate at least to a portion of the gas flow guide element close to the build area and/or to a portion including at least one of the gas supply portion and gas diversion portion.

According to a further embodiment, the fresh gas flow provided by the gas flow guide element is directed substantially in the same direction as the gas flow before it is partially diverted away from the build area, i.e. the direction of said gas flow while streaming along the build area. For example, the gas flow may flow along the axis in a specific direction, e.g. from the first edge region towards the second edge region. The fresh gas flow provided by the gas flow guide element may hence be provided, so as to substantially flow along said same axis and, in particular, in the same direction along said axis.

In summary, at least part of the gas flow provided by the device may be diverted away from the build area when reaching the gas flow guide element. The gas flow may then be continued with the fresh gas supplied by the gas flow guide element, said fresh gas flow extending preferably in the same direction as the gas flow that has been partially diverted. In other words, the gas flow guide element may at least partially interrupt the gas flow in between the first edge region and the second edge region and replace part of said gas flow with its own fresh gas flow. In this context, the gas flow may be provided by a gas inlet of a gas supply arrangement to flow towards a gas outlet of the gas supply arrangement, thereby being directed across the build area.

As further detailed below, it is, however, also conceivable that a plurality of gas flow guide elements is provided adjacent to one another. In this connection, a first gas flow guide element may be supplied with a gas flow provided by an adjacent second gas flow guide element. To put it differently, a gas flow comprising or being formed by the fresh gas flow provided by said adjacent second gas flow guide element may reach the first gas flow guide element after flowing along the axis extending between the first and second edge region. In this case, the first gas flow guide element may be configured to divert at least part of said gas flow away from the build area and/or to replace it with its own fresh gas flow which is preferably directed in the same direction,

In general, at least a gas diversion portion and/or the gas supply portion of the gas supply element flow guide element may be arranged above and/or opposite to the build area. According to a further example, the gas flow guide element is located between the first and second edge region of the build area and, preferably, a distance between the gas flow guide element and a central portion of the build area is the same or smaller than a distance between the gas flow guide element and at least one of the first and second edge regions. In other words, the gas flow guide element may be located closer to a central portion of the build area than to at least one of the first and second edge regions.

The gas flow guide element may be located at a position along the axis extending between the first and second edge region, wherein said position is located between the first and second edge region. The gas flow guide element may generally be arranged in or opposite to a central region of the build area, said central region e.g. comprising or being defined by a geometric centre of said build area. On the other hand, the gas flow guide element may be arranged outside of the central region. Yet, a distance to said central region may be the same or less than a distance to one or both of the first and second edge regions. In case of a plurality of gas flow guide elements, these may be arranged so that a distance to a directly adjacent gas flow guide element is the same or less then to at least one of the first and second edge regions. Note that any of the above-discussed distances may be measured along the gas flow axis extending between the first and second edge regions. In summary, by arranging the gas flow guide element(s) according to one of the above examples, it may be achieved that a timely refreshment of the gas flow takes place by means of the fresh gas flow provided by the gas flow guide element.

In one embodiment, the irradiation system comprises at least two irradiation units that are each assigned to an individual irradiation area of the build area to selectively irradiate a portion of the raw material powder layer extending into said irradiation area; and wherein the gas flow guide element is located in between said irradiation areas or wherein the gas flow guide element is located close or opposite to a region wherein said irradiation areas overlap.

The irradiation areas may define a certain part or share of the irradiation plane and/or the overall area that is to be irradiated. Specifically, the irradiation areas may comprise part of an irradiation plane extending in parallel to the carrier and, preferably, containing a raw material powder layer that is next to be irradiated. The irradiation areas as well as the irradiation plane may be virtual elements and, for example, may be defined by setting the scanning ranges of the irradiation system appropriately. The irradiation areas may be assigned individually to only one of the irradiation units, so that the respective irradiation unit is configured to irradiate any raw material powder extending into said irradiation area. The irradiation areas may also partially overlap each other, for example at adjacent edge regions thereof.

Accordingly, the gas flow guide element may be located in between the irradiation areas preferably in such a manner, that a gas flow that has passed a first one of the irradiation areas is at least partially or substantially completely diverted away from the build area by means of said gas flow guide element. Consequently, a gas flow for flowing along the further second irradiation area may be at least partially or substantially completely provided by means of the fresh gas flow provided by the gas flow guide element. The same may be achieved when arranging the gas flow guide element close opposite to an overlap region between the irradiation areas. In general and as further detailed below, the gas flow guide element may be configured (e.g. the designed or dimensioned) so as to not block any of the radiation from the irradiation units when travelling towards the irradiation areas.

The irradiation areas may be arranged, with an optional partial overlap, one behind the other along the gas flow axis extending from the first edge region towards the second edge region. Accordingly, the irradiation areas may each comprise at least one portion that extends along a specific section of the gas flow axis, wherein said sections are different from one another. Said a portion may comprise a central portion of the irradiation areas. To put it differently, the geometric centres of the irradiation areas may be arranged one behind the other along said gas flow axis.

The irradiation system may also comprise at least one further irradiation unit, assigned to an irradiation area that is defined so that the plurality of irradiation areas is arranged one behind the other along said gas flow axis, with an optional partial overlap between adjacent irradiation areas; and wherein for each group of two adjacent irradiation areas, at least one gas flow guide element is provided that is located between said two adjacent irradiation areas or wherein said gas flow guide element is located close or opposite to a region wherein said two adjacent irradiation areas overlap. Accordingly, a sequence of irradiation areas may be defined along the gas flow axis, such that at least one irradiation area may be enclosed by two outermost irradiation areas (i.e., at least one further irradiation area being arranged between a first and last irradiation area along said axis). Thus, a plurality of groups of adjacent irradiation areas is formed. In this context, the outermost irradiation areas may have only one adjacent irradiation area, wherein the enclosed or remaining irradiation areas may have two adjacent irradiation areas (i.e., one on each side). Accordingly, the outermost irradiation areas may belong to only one group of two adjacent irradiation areas, whereas the enclosed irradiation areas may be assigned to different two groups.

As an example, a first, a second and a third irradiation area may be arranged one behind the other along the gas flow axis. The first and third irradiation area thus form outermost irradiation areas which enclose the second irradiation area. The first irradiation area may be adjacent to the second irradiation area, whereas the second irradiation area may further be adjacent to the third irradiation area. Thus, a first group of two adjacent irradiation areas may be formed by the first and second irradiation areas and a second respective may be formed by the second and third irradiation areas, the second irradiation area thus being assigned to two respective groups of two adjacent irradiation areas.

The irradiation units and associated irradiation areas may generally form a subgroup of a pattern according to which said units and/or areas are arranged. For example, they may form at least part of a row or a column of a grid or matrix pattern, such as a four-by-four or two-by-three grid pattern according to which the irradiation units are arranged within the irradiation system and/or according to which the irradiation areas are arranged with respect to the build area. The gas flow guide element may be configured to extend between two adjacent rows or columns of such a grid or matrix pattern. Accordingly, the gas flow guide element may, by partially diverting it away from the build area, prevent at least part of a gas flow from passing from one row or column of said grid or matrix pattern to an adjacent row or column. Additionally or alternatively, the gas flow guide element may be configured to provide a fresh gas flow to said adjacent row or column.

In general, at least n-2 and preferably n-1 gas flow guide elements may be provided, wherein n denotes the total number of rows or columns of a respective grid or matrix pattern. The gas flow guide elements may then be distributed across said pattern, so that between each adjacent rows or columns, at least one gas flow guide element is provided. Overall, this means that each irradiation area assigned to an individual one of said irradiation units can be provided with an at least partially fresh gas flow. To put it differently, each irradiation area may be provided with a gas flow that has at least partially been refreshed and/or has not passed over more than one irradiation area prior to being at least partially refreshed. Again, refreshing the gas flow may take place by means of the fresh gas flow supplied by one of the gas flow guide elements.

According to a further example, the gas flow guide element extends from a region opposite the build area towards said build area. In this context, a distance between the gas flow guide element and the build area may be less than 10 cm, e.g. less than 5 cm, or less than 1 cm. Said distance may relate to a vertical distance or, in other words, a distance measured along an axis extending orthogonally to the build area. Accordingly, a predetermined gap may be formed between the build area and the gas flow guide element. A portion of the gas flow that is not diverted away from the build area by means of the gas flow guide element may pass through said gap. Alternatively, the gas flow guide element may also be arranged relative to the build area so that no substantial gap is formed therebetween (e.g be in contact with an uppermost raw material powder layer).

The gas flow guide element may be configured (e.g. designed, arranged and/or dimensioned) to extend outside an irradiation beam path between the irradiation system and the build area. In other words, the gas flow guide element may be configured so as to not block an irradiation emitted by the irradiation system from reaching the build area. For example, the irradiation system (or each of its irradiation units) may be configured to emit irradiation towards the build area under varying emission angles, e.g. by means of a suitable scanner unit. This way, an irradiation space through which the irradiation can travel between the irradiation system and the build area may be defined. The irradiation space may have a conical shape or a generally widening cross-section when viewed from the irradiation system towards the build area. In this context, the gas flow guide element may be configured so as to not extend into said irradiation space. In case of a plurality of irradiation units, the gas flow guide element may be arranged and/or shaped so as to extend in between adjacent irradiation spaces and, preferably, be positioned as close as possible to the build area without, however, extending within any of said irradiation spaces.

According to a further embodiment, the gas flow guide element is configured to collect particles that are carried by the diverted gas flow into the gas flow guide element. The particles may relate to particulate impurities within the gas flow and/or to single raw material powder particles being contained therein. Collection of such particles may be achieved by the gas flow guide element comprising a suitable filter element. Additionally or alternatively, a baffle plate or another suitable structure may be provided along or through which the diverted gas flow is guided, while at least part of the particles are separated from the gas flow. This way, the amount of particles that are carried further downstream into a gas circuit connected to the gas flow guide element can be limited. Specifically, the collection of particles may be done in such a manner, that an accumulation of particles close to and/or below of the gas flow guide element is avoided. This can be achieved by selecting a sufficiently strong gas flow which ensures that the particles actually enter the gas flow guide element and/or are transported further downstream into the gas circuit. Also, a collection member for collecting the particles, such as the above-mentioned filter or the baffle plate, may be arranged so as to reliably allow the particles to enter the gas flow guide element (i.e., not accumulating in front of it). Afterwards, however, the collection member may be configured to reliably keep said particles within the gas flow guide element and/or to promote that these particles are transported further downstream into the gas circuit.

In a further example, the gas flow guide element comprises at least one opening, preferably a plurality of openings and in particular a perforated or porous portion, that allows one the following:
at least part of the gas flow to pass into the gas flow guide element at positions remote from a gas diversion portion close to the build area, said gas diversion portion containing an opening to receive part of the gas flow for diverting it away from the build area; or
at least part of the fresh gas flow to pass out of the gas flow guide element at positions remote from the gas supply portion, said gas supply portion being preferably arranged close to the build area.

For example, the opening(s) and/or the perforated or porous portion may be provided alternatively or in addition to a gap being formed between the gas flow guide element and the build area and generally allow a predetermined portion of the gas flow to bypass said gap and/or said gas diversion portion. According to an additional or alternative configuration, at least one opening and/or a perforated or porous portion may be provided that allows part of the fresh gas stream to bypass the gas supply portion. The opening(s) and/or the perforated or porous portion may be located further away from the build area than the gas supply portion and/or gas diversion portion of the gas flow guide element. In one example, the gas supply portion and/or gas diversion portion are arranged at an underside portion of the gas flow guide element facing the build area. The opening(s) and/or the perforated or porous portion, on the other hand, may not be included in said underside portion (e.g. being vertically spaced apart therefrom or adjacent thereto). The perforated or porous portion may include numerous openings, preferably in form of a grid pattern. These may be formed in outer sidewalls of the gas flow guide element and/or may be smaller than openings of the gas supply portion or gas diversion portion. Moreover, the opening(s) and/or the perforated or porous portion may provide a fluidic connection to a central wall of the gas flow guide element. For example, a share of the gas flow entering the gas flow guide element through the perforated portion may hit said central wall and, preferably, be diverted thereby in a predetermined manner. Similarly, a share of the fresh gas flow flowing along said central wall may leave the gas flow guide element through the opening(s) and/or the perforated or porous portion prior to reaching the gas supply portion.

The gas flow guide element and the build area may be movable relative to each other according to at least one of the following:
the gas flow guide element being movable relative to the build area in parallel to the build area;
the gas flow guide element being movable relative to the build area between a position opposite to the build area and a position remote from the build area;
the gas flow guide element being movable relative to the build area along an axis extending at an angle to the build area;
the build area being movable relative to the gas flow guide element in parallel to the gas flow guide element;
the build area being movable relative to the gas flow guide element between a position opposite to the gas flow guide element and a position remote from the gas flow guide element; and
the build area being movable relative to the gas flow guide element along an axis extending at an angle to the build area.

Accordingly, the gas flow guide element may be movable relative to the build area along at least one axis extending in parallel to the build area, e.g. along an axis extending in parallel to a standard X- and Y-axis of the build area. Additionally or alternatively, the build area may be movable relative to the gas flow guide element in parallel to the gas flow guide element along at least one axis extending in parallel to the build area, e.g. along an axis extending in parallel to a standard X- and Y-axis of the build area.

Additionally or alternatively, the gas flow guide element may be movable towards and away from the build area, e.g. by selectively varying a distance thereto. This may be achieved by moving the gas flow guide element along an axis extending at an angle to the build area, wherein said axis extends preferably orthogonally to the build area. Any of these movements may be used to selectively move the gas flow guide element to a position opposite to the build area or remote therefrom. Additionally or alternatively, the build area may be movable towards and away from the gas flow guide element, e.g. by selectively varying a distance thereto. This may be achieved by moving the build area along an axis extending at an angle to the build area, wherein said axis extends preferably orthogonally to the build area. Any of these movements may be used to selectively move the build area to a position opposite to the gas flow guide element or remote therefrom.

In case the build area is movable relative to the gas flow guide element which in turn remains stationary, a constant gas flow can be maintained. The optical unit of the device may be movable relative to the gas flow guide element together with the build area. It is, however, also conceivable that the optic unit remains stationary when the build area is moved relative to the relative to the gas flow guide element.

In this context, the gas flow guide element may be movable relative to the build area in accordance with an operation of the powder application device. This way, it may be avoided that the gas flow guide element forms an obstacle for the powder application device, e.g. when said powder application device is an active state of deploying a raw material powder layer. Typically, the powder application device will move across the build area when deploying a raw material powder layer, such that the gas flow guide element may be selectively lifted away from the build area or generally be moved away therefrom so as to not interfere with said movement of the powder application device. In one example, the gas flow guide element is movable relative to the build area before and/or after the powder application device deploys a further layer of raw material powder onto the build area.

The device may also be configured to move the gas flow guide element relative to the build area and/or to move the build area relative to the gas flow guide element before the irradiation system has completed irradiating the raw material powder layer. Accordingly, irradiation of a raw material powder layer and a movement of the gas flow guide element and/or the build area may at least partially take place in parallel and/or in an interlaced manner. For example, the gas flow guide element and the build area may be kept as long as possible in a preferred position relative to each other and only selectively be moved away therefrom, e.g. so as to allow an irradiation of a region of the build area opposite to said preferred position. This may be particularly relevant when otherwise blocking a region of the build area from being irradiated. Accordingly, the gas flow guide element and/or the build area may be selectively moved between different locations, so that a region that was previously blocked by said gas flow guide element can be irradiated. This region may in particular contain an overlap area between adjacent irradiation areas as previously discussed. In summary, when irradiating a raw material powder layer, the gas flow guide element and the build area may change their position relative to each other prior to said irradiation having been completed. In particular, the gas flow guide element and/or the build area may be selectively moved back and forth between positions wherein the gas flow guide element is arranged opposite to or facing an overlap area between adjacent irradiation areas and positions remote from said overlap area, so that this overlap area can reliably be irradiated. These movements may be comparatively small, e.g. cover only few millimeters.

According to a further embodiment, for deploying a further raw material powder layer, the powder application device may be movable across the build area and the powder application device may comprise a receiving section for at least temporarily receiving part of the gas flow guide element while moving across the build area. The receiving section may comprise a cut-out, an opening and/or a recess into which a portion of the gas flow guide element may extend. Additionally or alternatively, the receiving section may generally partially surround the gas flow guide element. In general, the receiving section may be configured (e.g. sized and/or shaped) so as to allow for a relative movement between the powder application device and the gas flow guide element, preferably with a portion of the gas flow guide element being temporarily or even substantially constantly received within the receiving section.

In one example, the gas flow guide element extends within a non-parallel plane to the build area and the powder application device moves along an axis extending in parallel to or within said plane. In this context, the receiving section may be configured so as to enable this movement, i.e. so that the moving powder application device does not interfere with the gas flow guide element. For example, the receiving section may be provided in a region in which said plane and the powder application device intersect one another.

The invention further relates to a method for producing a three-dimensional workpiece by carrying out an additive layering process, in particular by means of a device according to one of the previous aspects, wherein the method comprises the following steps:
deploying a raw material powder layer onto a build area;
supplying at least one gas flow along an axis extending from a first edge region of the build area towards a second edge region of the build area;
diverting at least a part of the gas flow away from the build area before said gas flow reaches the second edge region; and
supplying supply a fresh gas flow along (at least part of) the build area,
   wherein diverting the gas flow and supplying the fresh gas flow take place in regions between the first and second edge regions.

The method may comprise any further steps or features for providing any of the interactions or effects described above and in the following. For example, the method may further comprise a step of moving a gas flow guide element and/or powder application device according to the above or below examples. Also, the method may comprise arranging the gas flow guide elements and/or irradiation areas as previously discussed. This may relate to arranging the gas flow guide elements with respect to a grid or matrix pattern of irradiation units and/or irradiation areas in the above- or below-described manner. Note that the regions between the first and second edge regions in which the diverting of the gas flow and supplying of the fresh gas flow take place, may be substantially the same or adjacent regions. Also, they may generally correspond to a position of a gas flow guide element.

In the following, several embodiments of the present invention will be discussed with reference to the attached drawings, in which

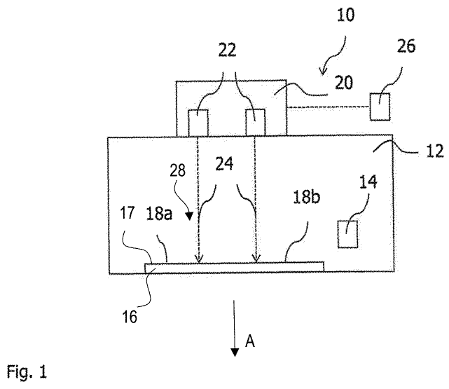

FIG. 1: shows a schematic representation of a device for producing three-dimensional workpieces;

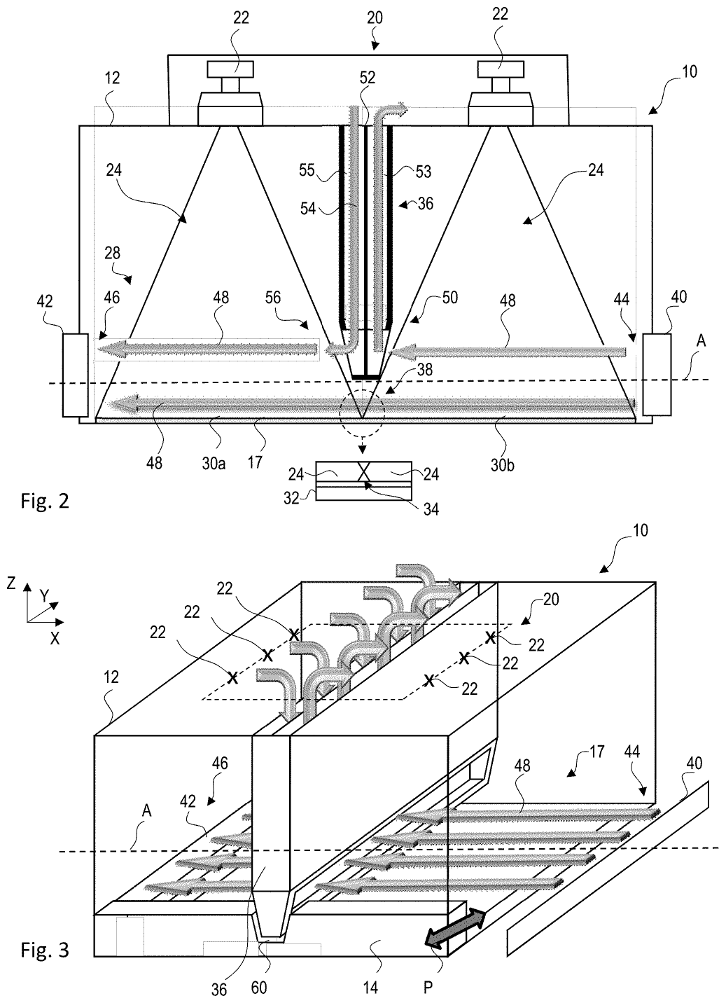

FIG. 2: shows a more detailed representation of the device of FIG. 1, including a gas flow guide element that is arranged oppositely to a build area;

FIG. 3: shows a detailed view of the gas flow guide element of the device of FIG. 1;

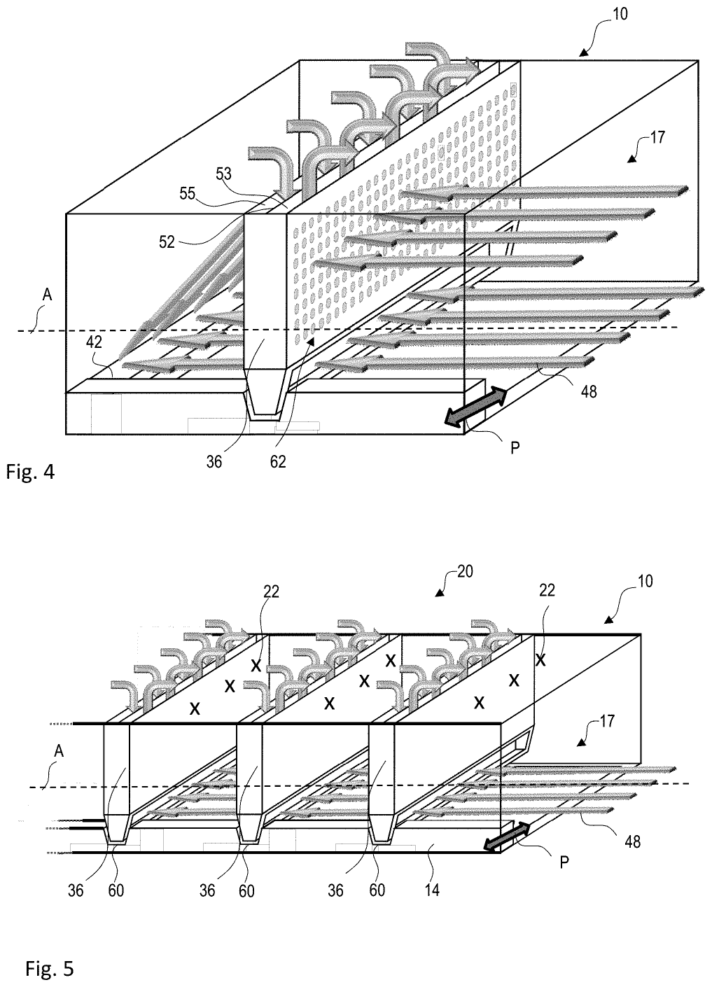

FIG. 4: shows a detailed view of a gas flow guide element according to a further embodiment;

FIG. 5: shows an arrangement of a plurality of gas flow guide elements to be used in a device according to a further embodiment;

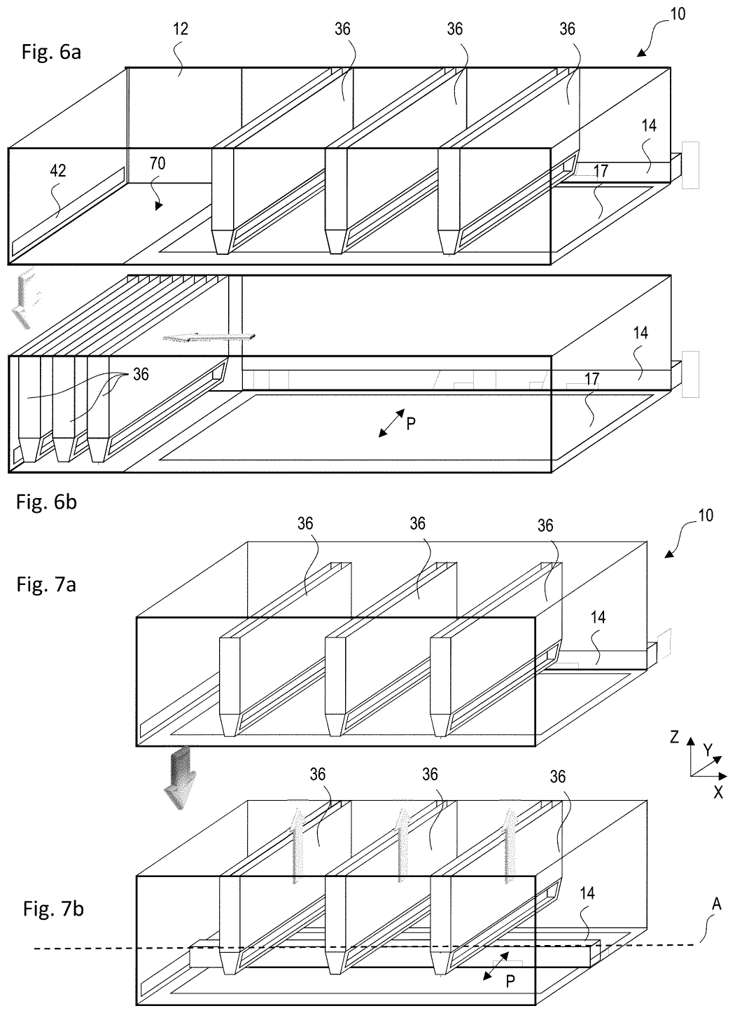

FIGS. 6a, 6b: show examples of moving a plurality of gas flow guide elements in parallel to the build area;

FIGS. 7a, 7b: show examples of lifting a plurality of gas flow guide elements away from the build area; and

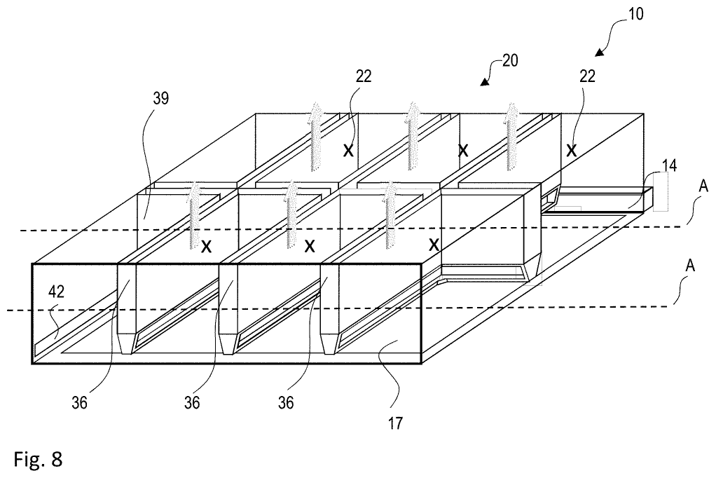

FIG. 8: shows a schematic view of a device according to a further embodiment.

In the following, different embodiments of devices according to the invention will be discussed, wherein said devices carry out a method according to the invention. The same reference signs may be used for same or equivalent features throughout said embodiments.

FIG. 1 shows a device 10 for producing three-dimensional workpieces by selective laser melting. The device 10 comprises a process chamber 12. A powder application device 14, which is disposed in the process chamber 12, serves to apply a raw material powder onto a carrier 16. As indicated by an arrow A in FIG. 1, the carrier 16 is designed to be displaceable in a vertical direction so that, with increasing construction height of a workpiece, as it is built up in layers from the raw material powder on the carrier 16, the carrier 16 can be moved downwards in the vertical direction. On its upper surface facing an irradiation system 20, the carrier 16 defines a build area 17 on which a workpiece can be built. On said build area 17, the raw material powder is deployed by the powder application device 14.

The irradiation system 20 is configured to selectively irradiate laser radiation onto the raw material powder applied onto the carrier 16. By means of the irradiation system 20, the raw material powder applied onto the carrier 16 may be subjected to laser radiation in a site-selective manner in dependence on the desired geometry of the workplace that is to be produced. The irradiation system 20 comprises a plurality of irradiation units 22 wherein each irradiation unit 22 is associated with one irradiation area defined within an irradiation plane 28 that extends in parallel to carrier 16 (see following Figures). It is understood that the irradiation areas as well as the irradiation plane 28 represent virtual areas, wherein the irradiation plane 28 further contains an uppermost raw material powder layer that is next to be irradiated.

Each irradiation unit 22 is configured to selectively irradiate an electromagnetic or particle radiation beam 24 (e.g. a laser beam) onto the raw material powder applied onto a respectively assigned irradiation area. As discussed below with reference to FIG. 3, the device 10 comprises six irradiation units 22 in total that are each arranged in a grid pattern and are assigned to an individual irradiation area (i.e., six irradiation areas in total). The irradiation units 22 selectively irradiate the raw material powder extending into a respectively assigned irradiation areas.

Each irradiation unit 22 may comprise a laser beam source. It is, however, also conceivable that plural irradiation units 22 are associated with a single laser beam source, wherein a radiation beam provided by the single radiation beam source, by suitable means such as, for example, beam splitters and/or mirrors, may be split and/or deflected as required so as to direct the radiation beam provided by the radiation beam source to the associated irradiation units 22. A laser beam source associated with only one irradiation unit 22 or with plural irradiation units 22 may, for example, comprise a diode pumped Ytterbium fibre laser emitting laser light at a wavelength of approximately 1070 to 1080 nm.

Further, each irradiation unit 22 may comprise an optical unit for guiding and/or processing a radiation beam 24 emitted by the radiation beam source and supplied to the irradiation unit 22. The optical unit may comprise a beam expander for expanding the radiation beam, a scanner and an object lens. Alternatively, the optical unit may comprise a beam expander including a focusing optic and a scanner unit. By means of the scanner unit, the position of the focus of the radiation beam 24 in the irradiation plane 28 (i.e., in a plane perpendicular to the beam path) can be changed and adapted. The scanner unit may be designed in the form of a galvanometer scanner and the object lens may be an f-theta object lens. The operation of the irradiation system 20 is controlled by means of a control unit 26.

By means of the control unit 26, each irradiation unit 22 is controlled such that the radiation beam 24 emitted by the irradiation unit 22 is irradiated onto the raw material powder applied within the respectively assigned irradiation area in a site selective manner and independent of the irradiation of other irradiation areas not associated with the irradiation unit 22 in question. In other words, each irradiation area defined on the carrier 16 (and/or in the irradiation plane 28) is individually and independently irradiated using a desired irradiation pattern. Thus, a large three-dimensional workpiece may be built-up on the carrier 16 in an additive layer construction process within a relatively short time and at reasonable costs by simultaneously irradiating said plurality of irradiation areas.

The process chamber 12 is sealable against the ambient atmosphere, i.e. against the environment surrounding the process chamber 12. As becomes apparent from the following figures, fresh gas is supplied to the process chamber 12 by means of a gas supply arrangement. The fresh gas supplied to the process chamber may be an inert gas such as, for example, Argon, Nitrogen or the like. It is, however, also conceivable to supply the process chamber 12 with air. The fresh gas is supplied to the process chamber 12 by means of a suitable conveying device such as, for example, a pump or a blower (not shown in the drawings).

Further, gas containing particulate impurities is discharged from the process chamber 12 with help of the gas supply arrangement as well as the gas flow guides elements discussed below. While the raw material powder applied onto the carrier 16 is selectively irradiated with electromagnetic or particle radiation, the fresh gas supplied to the process chamber 12 by means of the gas supply arrangement, upon flowing through the process chamber 12, is increasingly loaded with particulate impurities such as, for example, raw material powder particles or welding smoke particles and finally exits the process chamber 12 as gas containing particulate impurities (also referred to as “used gas”). Hence, particulate impurities generated in the process chamber 12 upon irradiating the raw material powder on the carrier 16 with electromagnetic or particle radiation are purged from the process chamber 12 by the gas flow guided through the process chamber 12. The gas containing particulate impurities is discharged from the process chamber 12 by means of a suitable conveying device such as, for example, a pump or a blower (not shown in the drawings). The gas containing particulate impurities which is discharged from the process chamber 12 may be directed through a filter (not shown in the drawings) and, after having passed the filter, may be recirculated into the process chamber 12 via the gas supply arrangement.

This becomes further evident from FIG. 2. In said figure, which contains a more detailed illustration of the device 10 according to FIG. 1, the process chamber 12 can again be seen. Also, the irradiation system 20 containing the two irradiation units 22 is shown. The irradiation units 22 face the build area 17. More specifically, it is shown that each irradiation unit 22 defines a conical irradiation space 24 containing the possible beam paths between the irradiation units 22 and the build area 17. Said beam paths may be set and varied by an optical unit, such as a scanner, of the irradiation units 22 in a generally known manner. Further, it becomes evident that each irradiation unit 22 is assigned to an individual irradiation area 30a,30b of the build area 17 (i.e, said irradiation areas 30a, 30b defining a share of the total irradiation area 28). Note that in FIG. 2, only two irradiation units 22 and irradiation areas 30a, 30b are shown. The further irradiation units 22 and irradiation areas 30a, 30b are arranged behind the depicted ones and are thus not visible in FIG. 2.

FIG. 2 also includes an enlarged view marked as 32 which shows an overlap area 34 between the two adjacent irradiation areas 30a, 30b.

In a position opposite to and facing said overlap area 34, a gas flow guide element 36 is arranged. As evident from FIG. 3 discussed below, said gas flow guide element 36 is designed as a generally planar member that extends in a plane running perpendicular to the build area 17. Also, an underside of the gas flow guide element 36 is slightly spaced apart from the build area 17, so that a vertical gap 38 remains therebetween. Note that the gas flow guide element 36 is also positioned opposite to a central region of the build area 17 and thus equally spaced apart from first and second edge regions 44, 46 thereof as discussed below. Moreover, the gas flow guide element 36 is shaped so as to not extend into the irradiation spaces 24 of the irradiation units 22. That is, the gas flow guide element 36 does not interfere with any radiation omitted by the irradiation units 22, so that the irradiation areas 30a,30b can be fully irradiated.

From FIG. 2, the previously discussed gas flow through the process chamber 12 becomes more evident. Specifically, a gas inlet 40 to the process chamber 12 as well as a gas outlet 42 from the process chamber 12 are shown, which both belong to a non-specifically illustrated gas supply arrangement of the device 10. The gas inlet 40 and gas outlet 42 are arranged at opposite edge regions 44, 46 of the build area 17. More precisely and as shown in FIG. 3, the gas inlet 40 is arranged at a first edge region 44 of the build area 17, whereas the gas outlet 42 is arranged at an opposite second edge region 46 of the build area 17. Note that the build area 17 has a rectangular shape, so that the first and second edge regions 44, 46 comprise opposite sides of said rectangular shape.

Coming back to FIG. 2, it can be seen that the gas inlet 40 provides a gas flow 48 which is directed along an axis A extending between the opposite edge regions 44, 46. Said axis A will also be referred to as “gas flow axis” in the following. Specifically, the gas flow 48 that enters the process chamber 12 at the first edge region 44 is a fresh gas. It then flows towards the gas outlet 42 across the build area 17 while picking up the previously discussed particular impurities. Thus, it leaves the process chamber 12 via the gas outlet 42 as used gas that is recycled within a non-depicted gas circuit of the gas supply arrangement in a generally known manner (e.g. by means of filter units).

As shown in FIG. 2, a certain share of the gas flow 48 is, however, diverted away from the build area 17 by means of the gas flow guide element 36. Specifically, said share of the gas flow 48 (cf. right upper arrow 48 in FIG. 2) enters a gas diversion portion 50 at an underside of the gas flow guide element 36 close to the build area 17, said gas diversion portion 50 comprising an opening. Following that, the entering share of the gas flow 48 hits a central wall 52 within the gas flow guide element 36, thereby being diverted vertically upwards through a first channel portion 53 of the gas flow guide element 36 and then away from the build area 17. As indicated by a respective upper arrow in FIG. 2, the diverted share of the gas flow 48 is then guided away from the gas flow guide element 36 into the non-depicted gas circuit of the gas supply arrangement.

Note that due to the arrangement of the gas flow guide element 36, the diverted share of the gas flow 48 has already passed the irradiation area 30b close to the gas inlet 40 and thus already picked up some particular impurities. Therefore, prior to reaching the adjacent irradiation area 30a, a part of the gas flow 48 is deliberately diverted away from the build area 17 by means of the gas flow guide element 36 to limit the amount of impurities which are carried over into the adjacent build area 30a. On the other hand, another share of the gas flow 48 is not diverted by the gas flow guide element 36 due to flowing through the vertical gap 38 and straightforward the gas outlet 42.

In fact, the gas flow guide element 36 even provides a fresh gas flow 54. More precisely, on a side facing away from the gas diversion portion 50 and instead facing the gas outlet 42, the gas flow guide element 36 comprises a gas supply portion 56. As indicated by respective arrows in FIG. 2, the fresh gas flow 54 is supplied from the non-depicted gas circuit into a second channel portion 55 of the gas flow guide element 36. Said second channel portion 55 extends in parallel to the first channel portion 53 but is separated therefrom by means of the central wall 52. In consequence, the fresh gas flow 54 enters the process chamber 12 by flowing through the gas supply portion 56 which, moreover, is shaped to direct the fresh gas flow 54 tangentially along the build area 17. Specifically, it can be seen that the fresh gas flow 54 extends in the same direction as the gas flow 48 and thus flows across the build area 17 towards the gas outlet 42. Again, due to the position of the gas flow guide element 36, this means that irradiation area 30a close of the gas outlet 42 is supplied with a defined volume of the fresh gas flow 54 in addition to the gas flow 48 flowing through the vertical gap 38.

In the shown example, the operation of the device 10 is controlled so that the volume of gas that is diverted away from the build area 17 as well as volume of the fresh gas flow 54 which is supplied to the build area 17, both by the gas flow guide element 36, approximately balance each other.

Overall, the gas flow supply element 36 thus ensures that the gas flow 48 is at least partially refreshed in predetermined intervals, wherein said intervals are defined so as to each contain one of the irradiation areas 30a,30b. This way, it is ensured that each irradiation area 30a,30b is supplied with at least a certain share of fresh gas, which increases the overall quality of the production process and the resulting workpiece. In the shown example, the irradiation area 30b close to the gas inlet 40 is supplied with fresh gas directly from said gas inlet 40, whereas the irradiation area 30a close to the gas outlet 42 is supplied with fresh gas from the gas supply portion 56 of the gas flow guide element 36.

With reference to FIG. 3, the configuration of the device 10 according to FIGS. 1 and 2 will be further discussed. FIG. 3 shows a perspective view of part of the process chamber 12. In this figure, the arrangement of the irradiation units 22 becomes more evident. Specifically, it can be seen that the irradiation units 22 are arranged in a three-by-two grid or matrix pattern (i.e., three rows of two irradiation units 22). Accordingly, three rows of two irradiation units 22 are provided with each row extending along the gas flow axis A. On the other hand, two columns of three irradiation units 22 are formed, with one column being arranged on each side of the gas flow guide element 36. That is, when viewed along the gas flow axis A, a first column of three irradiation units 22 is positioned between the gas flow guide element 36 and the gas inlet 40 and a second column of three irradiation units 22 is arranged on the opposite side between the gas flow guide element 36 and the gas outlet 42. As explained above, each irradiation unit 22 is assigned to an individual irradiation area, wherein the frontmost irradiation units 22 in FIG. 3 are assigned to the irradiation areas 30a,30b of FIG. 2. The irradiation areas are all equally sized and rectangularly shaped, wherein each row of the grid pattern of irradiation units 22 defines two adjacent irradiation areas which overlap below of the guide element 36. This corresponds to the adjacent irradiation areas 30a,30b forming the overlap 34 in FIG. 2. It is thus also evident that the irradiation areas 30a,30b as well as the further irradiation areas for each single row of the grid pattern of irradiation units 22 (not shown) are arranged one behind the other along the gas flow axis A.

In sum, for each row of the grid pattern, the gas flow guide element 36 is thus arranged between two adjacent irradiation areas when viewed along the gas flow axis A and, more precisely, arranged opposite to an overlap area between the two adjacent irradiation areas for each row of the grid pattern.

The gas flow guide element 36, on the other hand, completely spans across the build area 17. Specifically, a standard coordinate system for the device 10 is shown, in which the Z-axis corresponds to the so-called build axis and the X- and Y-axis define a plane that extends in parallel to the irradiation plane 28 as well as the build area 17. Therefore, it can be seen that the gas flow guide element 36 extends in a plane defined by the Y- and Z-axis and is arranged so as to span across the build area 17 when viewed along the Y-axis. To put it differently, the gas flow guide element 36 extends between two opposing edge regions of the build area 17, which are different from the first and second edge regions 44, 46 at which the gas inlet and outlet 40, 42 are arranged. Again, these edge regions correspond to opposite sides of the rectangularly shaped build area 17.

Due to this arrangement of the gas flow guide element 36, no share of the gas flow 48 can flow from the gas inlet 40 to the gas outlet 42 without interacting with the gas flow guide element 36 (i.e., by being diverted thereby or by passing underneath it). In particular when viewed along the Y-axis, the gas flow 48 will at least partially be diverted away from the build area 17 at each position along said axis. Similarly, all regions of the build area 17 between the gas flow guide element 36 and the gas outlet 42 are supplied with a fresh gas flow 54 from the gas flow guide element 36. In consequence, for each row of the grid pattern of irradiation units 22, the respectively adjacent irradiation areas will each be supplied with a certain share of fresh gas as explained above with reference to FIG. 2.

In FIG. 3, the powder application device 14 is shown in greater detail. In a generally known manner, said application device 14 moves across the build area 17 along an axis P extending in parallel to the Y-axis of FIG. 3 when deploying a new raw material powder layer. To not interfere with the gas flow guide element 36, which is generally stationary in the shown example, the powder application device 14 comprises a receiving section 60 in a region in which it would otherwise interfere with the gas flow guide element 36. Specifically, the powder application device 14 intersects the plane in which the gas flow guide element 36 extends. In said region of intersection, a cutout is formed within the powder application device 14 so as to receive an underside portion of the gas flow guide element 36. Said cutout forms the receiving section 60 of the powder application device 14.

In FIG. 3, the powder application device 14 is shown in an inactive position outside the build area 17, from which it can move to the opposite side of the build area 17 while deploying a new uppermost raw material powder layer. As explained above, the gas flow guide element 36 spans across of the build area 17 and even slightly into a region in which the powder application device 14 is located when assuming its inactive state. Thus, the gas flow guide element 36 extends into or, in other words, engages with the receiving section 60 even in said inactive state of the powder application device 14. This, however, is not a mandatory aspect of this embodiment or of the disclosure in general.

As further evident from FIG. 3, the gas flow guide element 36 and the powder application device 14 are arranged relative to one another in such a manner, that the powder application device 14 also move between opposite edge regions of the build area 17 along the axis P without interfering with the gas flow guide element 36 at any position.

Overall, due to providing the receiving section 60, the gas flow guide element 36 can be positioned as close as possible to the build area 17 and may even remain stationary in said position, while still allowing the powder application device 14 to operate as usual.

In FIG. 4, a further embodiment of the device 10 is shown which is generally similar to the embodiment of the previous figures apart from the design of the gas flow guide element 36. More precisely, said gas flow guide element 36 has a perforated portion 62 which is provided with a large number of holes (or openings) which are arranged in a regular grid pattern. These holes define access openings through which the gas flow 48 may enter the gas flow guide element 36 and hit the central wall 52. Thereby, it may be diverted away from the build area 17 into the first channel portion 53. On the side of the gas flow guide element 36 facing the gas outlet 42, a similar perforated portion 62 comprising a similar grid pattern of openings is provided (not visible in FIG. 4). A share of the fresh gas flow 54 passing through the second channel portion 55 may flow out of the gas flow guide element 36 through said further perforated portion 62. This share of the fresh gas flow 54 passing through the perforated portion 62 is sucked into the gas outlet 42. This is indicated by diagonal arrows which point towards the gas outlet 42 in FIG. 4.

Overall, this embodiment may help to reduce turbulences when the gas flow 48 reaches the gas flow guide element 36 by providing a defined possibility to bypass any of the vertical gap 38 or the gas flow diversion portion 50 of FIG. 1. Likewise, the perforated portion 62 on the side of the gas flow guide element 36 facing the gas outlet 42 provides a possibility to bypass the gas supply portion 56. This may help to limit turbulences in the fresh gas flow 54.

FIGS. 5 through 7 show further embodiments of the device 10 which are generally similar to those of the previous figures apart from the number and/or possible movements of the gas flow guide element 36. For example, in FIG. 5, three gas flow guide element 36 are provided. These extend in parallel to one another and are spaced apart from one another along the gas flow axis A. Moreover, it can be seen that the irradiation system 20 comprises a grid pattern of three-by-four irradiation units 22 (i.e., three rows of four irradiation units 22, with each row extending along the gas flow axis A). The irradiation units 22 are indicated as crosses above the build area 17, wherein not all of these crosses are provided with a respective reference signs.

Each irradiation unit 22 is again to assigned an rectangular individual irradiation area not shown). Thus, for each row of irradiation units 22, four irradiation areas are defined which are arranged one behind the other along the gas flow axis A, wherein two respectively adjacent irradiation areas slightly overlap one another (cf. FIG. 2 and overlap 34). Accordingly, the gas flow guide elements 36 are again arranged in such a manner, that when viewed along the gas flow axis A, two adjacent irradiation areas of each row of irradiation units 22 are, figuratively speaking, separated by a respective gas flow guide element 36. More precisely, the gas flow guide elements 36 are arranged oppositely to overlaps between such adjacent irradiation areas, so that the gas flow 48 cannot directly pass between said irradiation areas without being at least partially diverted away from the build area 17. Also, the gas flow guide elements 36 supply a fresh gas flow 54 to one of these adjacent irradiation areas as discussed above with reference to FIGS. 2 and 3.

In summary, FIG. 5 underlines the concept of refreshing the gas flow 48 across the build area 17 in predetermined intervals, said intervals being defined by the position of the gas flow guide elements 36. Likewise, it again becomes evident that the gas flow guide elements 36 can be arranged in such a manner, so that for each irradiation area for a plurality of irradiation units 22, the gas flow 48 contains at least a predetermined share of fresh gas.

For the sake of completeness, it should also be noted that the powder application device 14 of FIG. 5 comprises three receiving sections 60 which are each designed similarly to the embodiment of FIG. 3. Accordingly, the receiving sections 60 are positioned and shaped so as to allow a movement of the powder application device 14 across the build area 17 along the axis P without interfering with any of the gas flow guide elements 36.

FIGS. 6a,b and 7a,b show further embodiments of the device 10 which are similar to the embodiment of FIG. 5, apart from the three gas flow guide elements 36 being movable relative to the build area 17. For example, in FIGS. 6a,b, the gas flow guide elements 36 are each movable along the X-axis. For doing so, standard drive units may be provided, similar to the drive units of the powder application device 14. In FIG. 6a, the gas flow guide elements 36 have already started moving away from their active positions which correspond to those of FIG. 5. Accordingly, they started moving along the X-axis towards a storing region 70 within the process chamber 12, in which the gas flow guide elements 36 may be at least temporarily stored or parked outside of the build area 17. In other words, the storage region 70 allows for a movement of the gas flow guide elements 36 to a position remote from the build area 17 and in which the gas flow guide elements 36 are not arranged oppositely to any irradiation areas. This state is shown in FIG. 6b. In consequence, the build area 17 is completely free of obstacles, so that the powder application device 14 can move across the build area 17 for deploying a new uppermost raw material powder layer (cf. FIG. 6b). This means that the powder application device 14 can, optionally, also be designed without any of the receiving sections 60 of FIG. 5, since no interferences with the gas flow guide elements 36 are possible.

When operating the device 10, a controller may thus detect the need for a new uppermost raw material powder layer to be deployed and that the powder application device 14 should hence be activated. In consequence, the gas flow guide elements 36 will move from their positions opposite to the build area 17 to their positions within the storing region 70 remote from the build area 17 (cf. FIG. 6b). After the powder application device 14 has completed deploying the new raw material powder layer, the gas flow guide elements 36 are moved back into their original positions above the build area 17, said positions corresponding to those of FIG. 5.

FIGS. 7a,b show an alternative for selectively moving the gas flow guide elements 36 in accordance with an operation of the powder application device 14. In this case, the gas flow guide elements 36 can be selectively lifted away from the build area 17 to allow the powder application device 14 to pass underneath them while deploying a new uppermost raw material powder layer. In other words, the gas flow guide elements 36 can be moved up and down the Z-axis which extends orthogonally to the build area 17. Again, this does not make it necessary to configure the powder application device 14 with dedicated receiving sections 60. Also, in the state of FIG. 7a, the powder application devices 36 may be arranged very closely to the build area 17 so as to even contact the uppermost raw material powder layer. This way, the vertical gap 38 of FIG. 1 may be significantly reduced or even decreased to zero, so that less or even no share of the gas flow 48 can directly pass from adjacent one irradiation area to the next when viewed along the gas flow axis A.

Note that in FIGS. 5 to 7, each fresh gas flow 54 that is provided by one of the gas flow guide elements 36 and directed towards an adjacent gas flow guide element 36 represents a gas flow similar to the gas flow 48 of FIGS. 1 to 4, since it will be partially diverted away from the build area 17 by the respectively adjacent gas flow guide element 36.

Finally, FIG. 8 shows a further embodiment of a device 10 which is generally configured similar to the device of FIG. 5. In addition thereto, however, a central gas flow guide element 39 is provided intersecting all of the remaining gas flow guide elements 36 and extending along the gas flow axis A. The central gas flow guide element 39 is arranged so as to substantially completely isolate the single irradiation areas from one another in terms of an exchange of gas flows therebetween. As further shown in FIG. 8, the central gas flow guide element 39 can provide such an effect for an irradiation system 20 comprising two rows of three irradiation units 22. Accordingly, each irradiation area assigned to one of the irradiation units 22 and arranged oppositely thereto is supplied with fresh gas from either the gas inlet 40 (not shown) and/or an adjacent gas flow element 36. To underline this aspect, two gas flow axes A are shown in FIG. 8, one for each row of irradiation units 22 of the irradiation system 20.

Also, similar to the embodiment of FIGS. 7a,7b, the gas flow guide elements 36 and the central gas flow guide element 39 can be lifted away from the build area 17 for not interfering with the powder application device 14 (cf. arrows in FIG. 8).

1-15. (canceled)

16. A device for producing a three-dimensional workpiece by carrying out an additive layering process,
wherein the device comprises:
a build area that is configured to receive a raw material powder layer;
a powder application device that is configured to deploy the raw material powder layer onto the build area;
an irradiation system that is configured to selectively irradiate the raw material powder layer on the build area;
wherein the device is configured to provide at least one gas flow that is directed along an axis extending from a first edge region of the build area towards a second edge region of the build area;
wherein the device comprises at least one gas flow guide element that is configured to divert at least part of the gas flow away from the build area before said gas flow reaches the second edge region;
wherein the gas flow guide element comprises a gas diversion portion configured to receive gas in order to divert the gas away from the build area, such that the gas flow guide element is configured to remove and/or discharge the at least part of the gas flow on its way across the build area; and
wherein the gas flow guide element comprises a gas supply portion that is configured to supply a fresh gas flow along the build area.

17. The device according to claim 16,
wherein said fresh gas flow is substantially directed in the same direction as the gas flow before it is partially diverted away from the build area.

18. The device according to claim 16,
wherein the gas flow guide element is located between the first and second edge region of the build area and, preferably, wherein a distance between the gas flow guide element and a central portion of the build area is the same or smaller than a distance between the gas flow guide element and at least one of the first and second edge regions.

19. The device according to claim 16,
wherein the irradiation system comprises at least two irradiation units that are each assigned to an individual irradiation area of the build area to selectively irradiate a portion of the raw material powder layer extending into said irradiation area; and
wherein the gas flow guide element is located in between said irradiation areas or wherein the gas flow guide element is located close or opposite to a region wherein said irradiation areas overlap.

20. The device according to claim 19,
wherein the irradiation areas are arranged, with an optional partial overlap, one behind the other along a gas flow axis extending from the first edge region towards the second edge region.

21. The device according to claim 20,
wherein the irradiation system comprises at least one further irradiation unit, assigned to an irradiation area that is defined so that the plurality of irradiation areas is arranged one behind the other along said gas flow axis, with an optional partial overlap between adjacent irradiation areas; and
wherein for each group of two adjacent irradiation areas, at least one gas flow guide element is provided that is located between said two adjacent irradiation areas or wherein said gas flow guide element is located close or opposite to a region wherein said two adjacent irradiation areas overlap.

22. The device according to claim 16,
wherein the gas flow guide element extends from a region opposite the build area towards said build area and, optionally, wherein a distance between the gas flow guide element and the build area is less than 10 cm.

23. The device according to claim 16,
wherein the gas flow guide element is configured to extend outside an irradiation beam path between the irradiation system and the build area.

24. The device according to claim 16,
wherein the gas flow guide element is configured to collect particles that are carried by the diverted gas flow into the gas flow guide element.

25. The device according to claim 16,
wherein the gas flow guide element comprises at least one opening and in particular a perforated or porous portion, that allows one of the following:
at least part of the gas flow to pass into the gas flow guide element at positions remote from a gas diversion portion close to the build area, said gas diversion portion containing an opening to receive part of the gas flow for diverting it away from the build area; or
at least part of the fresh gas flow to pass out of the gas flow guide element at positions remote from the gas supply portion, said gas supply portion being preferably arranged close to the build area.

26. The device according to claim 16,
wherein the gas flow guide element and the build area are movable relative to each other according to at least one of the following:
the gas flow guide element being movable relative to the build area in parallel to the build area;
the gas flow guide element being movable relative to the build area between a position opposite to the build area and a position remote from the build area;
the gas flow guide element being movable relative to the build area along an axis extending at an angle to the build area;
the build area being movable relative to the gas flow guide element in parallel to the gas flow guide element;
the build area being movable relative to the gas flow guide element between a position opposite to the gas flow guide element and a position remote from the gas flow guide element; and
the build area being movable relative to the gas flow guide element along an axis extending at an angle to the build area.

27. The device according to claim 26,
wherein the gas flow guide element is movable relative to the build area in accordance with an operation of the powder application device.

28. The device according to claim 26,
wherein the device is configured to move the gas flow guide element relative to the build area before and/or after the powder application device deploys a further layer of raw material powder onto the build area.

29. The device according to claim 16,
wherein for deploying a further raw material powder layer, the powder application device is movable across the build area; and
wherein the powder application device comprises a receiving section for at least temporarily receiving part of the gas flow guide element while moving across the build area.

30. A method for producing a three-dimensional workpiece by carrying out an additive layering process, in particular by means of a device according to claim 1,
wherein the method comprises the following steps:
deploying a raw material powder layer onto a build area;
supplying at least one gas flow from a first edge region of the build area towards a second edge region of the build area;
diverting at least a part of the gas flow away from the build area before said gas flow reaches the second edge region; and
supplying a fresh gas flow along the build area,
wherein diverting the gas flow and supplying the fresh gas flow takes place in regions between the first and second edge regions.
